(19) United States
(12) Patent Application Publication
(10) Pub. No.: US 2007/0280438 A1
(43) Pub. Date: Dec. 6, 2007

(54) Method and apparatus for converting a daisy format file into a digital streaming media file

(75) Inventors: James W. Pritchett, Princeton, NJ (US); Peter Beran, Bridgewater, NJ (US)

Correspondence Address: SYNNESTVEDT LECHNER & WOODBRIDGE LLP, P O BOX 592, 112 NASSAU STREET, PRINCETON, NJ, 08542-0592, US

(73) Assignee: Recording for the Blind & Dyslexic, Incorporated, Princeton, NJ (US)

(21) Appl. No.: 11/436,148

(22) Filed: May 17, 2006

(51) Int. Cl. H04M 11/00

(52) U.S. Cl. 379/88.13

(57) ABSTRACT

A method and apparatus for converting a Daisy format digital talking book file into a conventional digital streaming media file. The method includes accessing administrative information in a Daisy file, identifying a start and end point for a specific audio portion of the digital talking book, parsing the specific audio portion from the Daisy file, creating a new audio file using the parsed audio portion, adding a header to the new audio file, and saving the new audio file.

### BACKGROUND OF THE INVENTION

1. Field of the Invention

Embodiments of the invention generally relate to a method and apparatus for converting a data file representing a digital talking book into another data file that is readable by a generic digital media player.

2. Description of the Related Art

Digital talking books have become very popular in the market. These types of books are especially helpful for those who are challenged in any way to physically read a book, such as blind person or a person with a learning disability. One of the more popular formats for digital talking books is the Daisy format, as this format allows for excellent navigation throughout the book during the playback process. For example, using the Daisy standard, a user is able to navigate through a digital talking book on a chapter basis, on a page basis, on a paragraph basis, or on a line by line basis, which has been shown to be a very powerful tool in the digital talking book market.

However, one challenge associated with the Daisy format digital talking books is that books in the Daisy format require a specialized Daisy-type player. The Daisy players are somewhat expensive, and although they are available on the market, they are not nearly as available as current digital streaming media players. These types of players include MP3 players, i-Pods, etc. As such, users of the Daisy players may desire to play the Daisy formatted digital talking books on conventional and widely available players. The difference between Daisy players and conventional digital music players is that Daisy navigation is based on the NCC/NCX and SMIL technologies, support for which are not implemented in conventional digital media players. Digital music players can play the audio files, but cannot provide the navigation features provided by Daisy-type players and files.

In view of the desirability of Daisy-type digital talking books, the price and availability of Daisy players, and the price and availability of conventional digital streaming media players, it would be desirable to have a method for converting the Daisy formatted digital talking books into a format that may be played on conventional digital streaming media players, while maintaining the navigation characteristics present in the Daisy digital talking books.

### SUMMARY OF THE INVENTION

The present invention generally relates to a method and apparatus for converting a data file set representing a digital talking book into another data file set that is readable by a generic digital media player that is readable by a generic digital media player, while providing similar navigation functions.

Embodiments of the invention may further provide a method and apparatus for converting a Daisy digital talking book data file set into a plurality of conventional digital streaming media files that may be played on a conventional digital streaming media player. Further, embodiments of the invention provide a method for converting the Daisy data file sets to data files that may be played on a conventional digital streaming media player, while maintaining the navigation characteristics of the Daisy digital talking book.

Embodiments of the invention may further provide a method for converting a Daisy digital talking book data file set. The method includes accessing administrative information in a Daisy file, identifying a start and end point for a specific audio portion of the digital talking book, parsing the specific audio portion from the Daisy data file set, creating a new audio file using the parsed audio portion, adding a header to the new audio file, and saving the new audio file.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of an apparatus that is used to perform one embodiment of the invention;

FIG. 2 illustrates a general flowchart of an exemplary method for converting Daisy files into digital streaming media of the invention;

FIG. 3 illustrates a more detailed flowchart of an exemplary Daisy file conversion method of the invention; and

FIG. 4 illustrates an exemplary data structure for a Daisy digital talking book and an exemplary data structure generated by an exemplary method of the invention configured to convert the Daisy data structure into one or more data files that can be read by a conventional digital streaming media player.

### DETAILED DESCRIPTION

Since one component of the present invention is converting a Daisy-based digital talking book into another type of navigable digital media, it is practical to begin with a brief explanation of the Daisy standard, the format of Daisy standard-type books, and the operational characteristics of a Daisy standard book. Similarly, once the brief description of the Daisy standard has been presented, a brief discussion of common media types and standards (MPEG, MP3, WAV, WMA, WMV, WINAMP, Windows Media, Advanced Streaming Format, MC, etc.) will also be presented. It should be noted that within this disclosure, these audio formats are cooperatively and generally referred to as “digital streaming media” files, however, the phrase digital streaming media is not in any way meant to be limited to the listed file formats or to any particular delivery method, i.e., the media files are not limited to streaming media files. Rather, the phrase digital streaming media is intended to represent any and all audio or video media formats where a user can sequentially and selectively listen or view files, as with the formats listed above, and many other common audio and video formats that are not listed, but which are contemplated within the scope of the invention.

Digital talking books (DTB) generally comprise of a collection of digital files that cooperatively provide an audio representation of a printed book. The audio representation is generally advantageous for individuals who are blind, visually-impaired, print-disabled, or otherwise unable to read a printed publication without assistance. The collection of digital files generally contain digital audio recordings of human or synthetic speech representing the print contents of a book, marked up text, and/or a range of machine-readable files, all of which may be presented to a user in an audio format once converted by the method of the invention.

The structure of a DTB based upon the DAISY standard is designated by the XML tags in the DTB data and is accessible to the reader through use of a browser or a playback device. The DAISY DTB utilizes the technology of the Internet with some specialized applications added to provide greatly improved- access to the information. For example, the DAISY standard supports the following types of DTBs:

1) Audio with Title element only: This type of DTB is essentially without structure. This is the simplest type of DTB and is used for books where structure will not be applied. The XML textual content file may not be present, or if it is, it generally contains only the title of the book, and other required notation. The book must be read linearly, and direct access to specific points within the DTB is not possible.

2) Audio with NCX (Navigation Control File for XML Applications): This type of DTB includes structure. The NCX is the Navigation Control Center, which is a file containing all of the points within the book to which the user may navigate. The XML textual content file, if present, contains only the structure of the book and may contain links to features, such as narrated footnotes, etc. This is the most common form of DTB and works well for stand-alone players.

3) Audio with NCX and partial text: This type of DTB includes structure and some additional text. The XML textual content file contains only the structure of the book and the text of components where keyword searching and direct access to the text would be beneficial, e.g., index, glossary, etc.

4) Audio and full text: This type of DTB includes structure, complete text, and complete audio. This form of a DTB is the most complex, but provides the greatest level of access for the user. The XML textual content file contains the structure and the full text of the book, and the audio and the text portions of the DTB are synchronized together during playback.

5) Full text and some audio: This type of DTB includes structure, complete text, but only includes limited audio. The XML textual content file for this DTB contains the structure and the text of the book. The audio files contain recordings of parts of the text. This type of DTB would be well suited for use as a dictionary, for example, as only pronunciations would be provided in audio form.

6) Text and no audio: This type of DTB includes E-text with structure. The XML textual content file contains the structure and text of the book, but there are no audio files.

XML provides the producer with the ability to structure a book in great detail. Compared to HTML markup, XML increases markup options and makes more detailed structure and proper nesting possible. A DTB produced under DAISY generally includes some or all of the following files: A Package File containing administrative information about the DTB, the files that make it up, and how these files interrelate; A textual content file containing some or all of the text of the book with appropriate markup; Audio files containing the human voice recording and/or synthetic speech rendering of the book; SMIL (Synchronized Multimedia Integration Language) file(s) containing information linking the audio and textual content files; and NCX—a file containing all points in the book to which the user may navigate.

The XML Document Type Definition (DTD) used for the textual content files of DAISY DTBs is generally the DTBook DTD. Its filename is generally dtbook-2005-1.dtd, and it is a machine-readable list of allowable tags, the attributes that may be applied to them, and rules on where the tags may be used. For example, sentence tags (<sent>) can be used inside paragraph tags (<p>), but not the other way around. To verify that a document has been marked up in accordance with a DTD, one runs a program called a validating parser that compares the markup with the DTD and lists any errors that may be present in tags, attributes, etc.

As of the filing date of this application, the current version of the DTD (2005) can be found at http://www.daisy.org/z3986/2005/dtbook-2005-1.dtd. However, please note that as DTDs are machine-readable, and therefore, they require considerable knowledge of DTDs to interpret the information within the file. The above noted 2005 version of the DTD is hereby incorporated by reference in its entirety into the present application to the extent not inconsistent with the claimed invention.

The NCX is a critical component of the user interface of the book in that it provides a view of all the points in a text to which a user may navigate. Each navigation point in the NCX is linked through the SMIL file to the corresponding location in the audio and XML textual content files, providing direct access to that location. The NCX may not be identical to the table of contents (TOC) of the printed edition. (It will usually contain more elements of the book than the TOC does.) For DTBs containing an XML textual content file the NCX is generated from the XML markup. The way in which the markup is applied will determine what is contained within the NCX

Generally speaking, an analogue book on cassette without some sort of tone indexing does not allow the user to navigate directly to various points within the book. Similarly, a DTB without the markup language is equally inaccessible, as there is no way to access particular points within the DTB absent the markup language. When a book is prepared for recording for analogue cassette format, a chapter and an appendix usually fit in the same level of the tone index hierarchy and are therefore treated in the same way. In terms of access, distinguishing these elements as different from each other is unimportant. Each is identified by a tone or a set number of tones. This, however, is not the case when producing a DTB. In the digital world, distinguishing one structural element from another is of great importance. When an element is identified and marked up, properties special to that element can be assigned to it, resulting in increased flexibility and enhanced navigation for the end user. For example, in an analogue recording the narrator pronounces or spells out an acronym, as appropriate. In a DTB containing a text file that may be accessed by a browser with synthetic speech, it is important for the markup to indicate if the acronym should be spelled out or pronounced. Whether the acronym is to be spelled or pronounced is a property assigned to the acronym tag. Furthermore, when elements are identified, they can be displayed according to user needs. A user may not want to hear the sidebars in a book. If the sidebars are identified and marked up with the sidebar tag the end user can choose to skip them, listen to them as they occur, or even listen only to them.

In short, markup is the identification and tagging of the components of a text. The more detailed the markup, the greater the access provided to the end user. A markup tag is a portion of text that describes an element (a unit of data) in XML. An element is a unit of XML data which is delimited by tags. The tag is distinguishable as markup, as opposed to data, by the angle brackets (<and >) which surrounded. With very few exceptions, tags are used in pairs to identify the start and end of the element. Note that the end tag contains a slash “/”. In the following example, the <q> tag is used to mark a short quotation:

An attribute functions somewhat like an adjective, providing more information about the structure a tag identifies. Generally, an attribute is a qualifier on an XML tag that provides additional information. One of the most commonly used attributes is “class”. In the following example, class=“chapter” indicates that the “level” tag begins a chapter section: <level1 class=“chapter”> . . . </level1>. The attribute “id” is heavily used to uniquely identify each structural element of the book. Other uses of attributes include indicating whether or not an item may be “turned off” as part of a group of items the user wishes to skip, and indicating if an acronym should be pronounced as a word or spelled out letter by letter, as mentioned earlier. An attribute, if used, will generally appear in the start tag and the value of the attribute (in the above example, “chapter”) must be in quotes. One attribute which requires special mention is “smilref.” It is used to synchronize the textual content file and the SMIL file when a user moves between navigation controlled by the SMIL file and navigation controlled by the textual content file. DAISY requires that it be present and have a value for each element in the textual content file that is referenced by a SMIL file. Both the SMIL file and textual content file are generally present before these attributes are valued, so they will normally be generated by software reading both files.

There are several tags that are generally required for a book to be valid to the DTBook DTD v 2005-1. The complete DAISY DTB is surrounded by the <dtbook> and </dtbook> tags. Within these, the <head> and </head> and <book> and </book> tags are generally present in this order as shown, and as generally required by the DTD. The <head> tags identify information about the book that is separate from the content. The <book> tags enclose the content of the book. Within <book>, the content is generally be divided into three sections called front matter, body matter, and rear matter, presented in that order and tagged with the elements <frontmatter>, <bodymatter>, and <rearmatter>. The front matter consists of information found in the preliminary pages of a book (e.g., title, author, book jacket material, foreword, acknowledgements, dedication, and table of contents) as well as information added by the talking book producer (e.g., date of recording, narrator, studio, special copyright message). The body matter of a book consists of the basic content of the document as distinguished from prefatory and supplementary materials. The body matter may be divided into parts, chapters, sections, etc. The rear matter consists of material following the main body of the book. Examples are: appendices, bibliographies, alphabetical indexes, etc. These items are generally presented in the sequence found in the printed book. In summary, the following list shows content belonging to frontmatter, bodymatter, and rearmatter: Frontmatter {Title, Author, Book jacket information, Dedication, Table of contents, etc.}; Bodymatter {Part 1, Chapters 1-3, Part 2, Chapters 4-6, etc.}; and Rearmatter {Glossary, Appendices, Bibliography, Index.}.

The main elements of a document, such as parts, chapters, sections, stanzas, etc., and their interrelationships, constitute its primary structure. These are ordinarily arranged hierarchically. For example, a novel consisting of an introduction and ten chapters has a very simple structure of eleven elements all at the same hierarchical level. On the other hand, a textbook containing parts, chapters, and sections has a more complex structure with text elements at three hierarchical levels: parts at the highest level, chapters at the middle level, and sections at the lowest level. Appropriate markup is used to identify the proper hierarchical structure of a document.

Levels describe the relative position of the major structural elements of a book. The hierarchy they define provides the end user with the ability to navigate within the DTB. Therefore it is critical that the markup of levels be correct. Two methods of marking up levels are allowed by dtbook-2005-1.dtd. The first uses six tags: <level1>, <level2>, <level3>, etc., through <level6>, with the highest level of a book tagged as <level1>. The second method uses a single <level> tag to mark all levels, with differences between the levels defined by nesting hierarchy or alternatively, the “depth” attribute. In the following examples and discussion, only the level1 through level6 method is described. A level is marked up in the following way. Determine at which level the structural component (part, chapter, section, etc.) occurs in the original document. The class attribute may be used to name (identify) it. The use of class attributes is not required, however, in some players they may provide additional information to the user.

In a DTB that is valid to the DTD and the DAISY Standard, (and thus produced according the requirements of XML), components at different levels in the hierarchy must be nested, that is, contained one within the other. This means that a component at a lower level will generally fit completely inside the higher level. In other words, when a second tag is opened before the previous tag is closed, proper nesting must be observed—the second tag must be closed before the first is closed.

The hierarchy in the DTB will generally reflect the hierarchy in the print book. The markup used in the DTB to represent the hierarchy determines the extent of the “global” navigation (from heading to heading) available to the end user. In most cases, only structural components with headings will be identified using the level1 to level6 tags. Components such as acknowledgements or dedication sometimes appear in the print book without a heading, in which case they should be marked up with the <div> tag.

The inventors note that the description of the Daisy standard provided herein is based upon ANSI/NISO Z39.86, and does not cover the earlier DAISY 2.02 standard. However, the inventors note that the earlier, and later, standards are intended to be covered by this invention, and therefore, these standards are hereby incorporated by reference into the present application. Generally speaking, to span across the various standards, the characteristics DaisyY DTB that are essential to the present invention are the same in both versions of the standard, namely: 1) The NCC (in 2.02) or NCX (in Z39.86) identifies navigable points in the DTB, such as pages or chapters; 2) the NCC/NCX identifies where these points occur in the multimedia presentation of the DTB by pointing to a specific point in a SMIL file; 3) the SMIL file defines the specific audio files and specific segments within those files that correspond to the book content at that navigation point; 4) MP3, AAC or WAV files contain the actual audio data. In a Daisy player, then, navigation is achieved by selecting a point in the NCC/NCX, finding which audio file contains the start of that navigation point by looking this up in the referenced SMIL file, finding out the correct time offset for the navigation point in the audio file, again using the referenced SMIL file, and then playing the audio file from that point.

Returning to the discussion of the invention, the contents of a DTB will generally be presented to the end user in the order in which they appear in the printed book. That sequence does not necessarily relate to the physical location of the digital information in a DTB (that is, items that follow each other in the book may be located in different files in the DTB), or to the order in which the contents were recorded (that is, a note that is read at the end of a sentence in the DTB may in fact have been recorded on a different day than the sentence was). Proper sequence is especially important for the end user who does not navigate randomly through the DTB, but instead listens to it from beginning to end. Although this presentation and flow method are generally preferred in the DTB art, this limitation is not binding, as a DTB may be configured to flow or read in any sequence desired.

Turning from the discussion of Daisy formatted data, MP3, for example, is one of the more popular formats for digital streaming media. The MPEG acronym stands for Motion Picture Experts Group and it refers to a group of searchers who study new formats for coding and playing audio and video; this acronym refers to audio/video compression formats created by this group. The term MP3 is the abbreviation of MPEG1-Layer 3, which is the audio compression format used in the MPEG 1 algorithm. In other words, MPEG is a series of compression algorithms to reproduce audio and video; the Layers are compression algorithms used in MPEG playing only for audio; MPEG 1-Layer 3, known as MP3, is one of the audio compression algorithm used by MPEG 1 algorithm. At the beginning or end of an MP3 file, “ID3” tag information may be stored, possibly including artist and title, copyright information, terms of use, proof of ownership, an encapsulated thumbnail image, and comments. There are actually two variants of the ID3 specification: ID3v1 and ID3v2, and while the potential differences between them are great, virtually all modern MP3 players can handle files with tags in either format (though a few older players will have problems with ID3v2 tags). Not only are ID3v2 tags capable of storing a lot more information than ID3v1 tags, but they appear at the beginning of the bitstream, rather than at the end. The reason for this is simple: When an MP3 file is being broadcast or streamed rather than simply downloaded, the player needs to be able to display all of this information throughout the duration of the track, not at the end when it's too late.

Other digital streaming media standards generally have the same format as the MP3-type format. That is, most mainstream digital media formats have a data file representative of the audio or video contained in the data file, where the data file contains a header-type portion that contains administrative and informational content related to the media in the file. Although the exact format of the data files is different between each standard, the operational concept is generally the same in that the header provides all of the relevant information on the file for the player to process and present the audio or video file to the user.

Another type of audio file that may be used in embodiments of the invention is Advanced Systems Format (ASF), which is Microsoft's proprietary digital audio/digital video container format, that is specifically configured for streaming media. ASF is part of the Windows Media framework, and the format does not specify how audio should be encoded, but instead simply specifies the structure of the audio stream. What this means is that ASF files can be encoded with basically any audio codec and still would be in ASF format. This is similar to the function performed by the QuickTime, AVI, or Ogg formats. The ASF format is based on serialized objects which are essentially byte-sequences identified by a GUID marker. The most common filetypes contained within an ASF file are Windows Media Audio (WMA) and Windows Media Video (WMV). ASF files can also contain objects representing metadata, such as the artist, title, album and genre for an audio track, or the director of a video track, much like the ID3 tags of MP3 files. Files containing only WMA audio can be named using a .wma extension, and files of only audio and video content may have the extension .wmv.

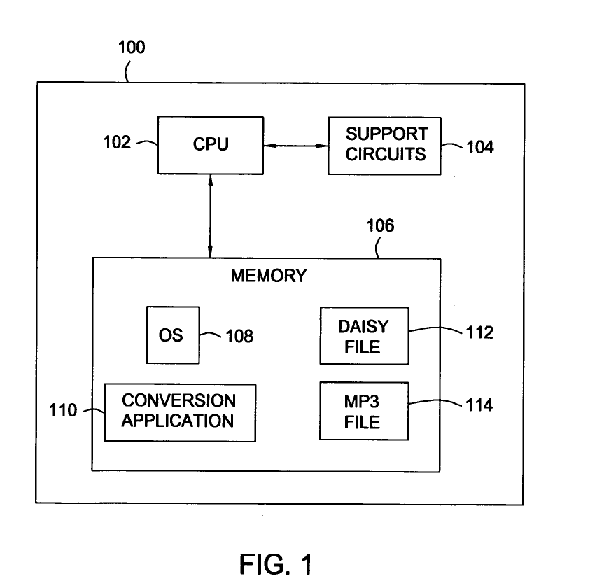

FIG. 1 depicts a block diagram of an apparatus 100 that forms one embodiment of the present invention. The apparatus may be a general purpose computer that operates as a specific purpose Daisy file converter when executing certain application software. The apparatus 100 comprises a central processing unit (CPU) 102, support circuits 104, and memory 106. The CPU 102 may comprise one or more commercially available microprocessors or microcontrollers. The support circuits 104 are well-known circuits used to facilitate the function of the CPU 102. The support circuits 104 comprise at least one of clock circuits, cache, power supplies, network interface circuits, input/output circuits and the like. The memory 106 comprises one or more of random access memory, read only memory, removable memory, disk drives, and the like. The memory 106 stores a commercially available operating system (e.g., WINDOWS, LINUX, and the like), a conversion application 110, a Daisy file 112 to be converted and an MP3 file that is the result of the conversion. The CPU 108 executes the conversion application 110 to perform the method of the present invention as discussed below.

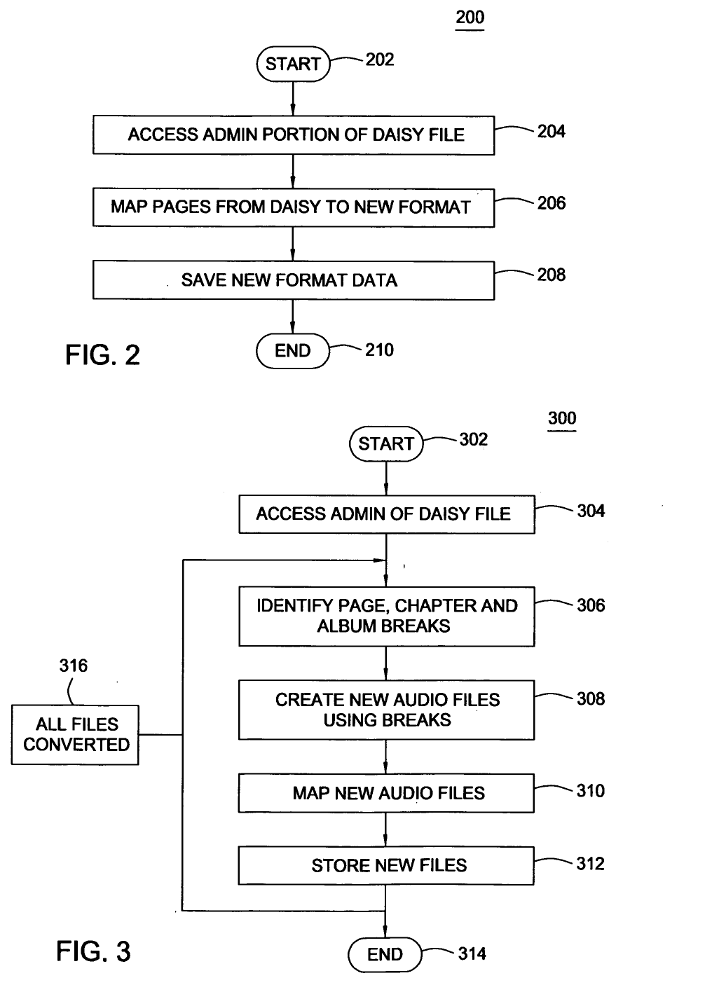

FIG. 2 illustrates a general flowchart of an exemplary method 200 for converting Daisy DTB files into digital streaming media. The exemplary method begins at step 202 and continues to step 204, where the method accesses the administrative information from the Daisy DTB file. The administrative portion of a Daisy DTB generally includes the Package File, the SMIL files, and the NCX information. This information generally operates to index the audio information contained in the audio files for the DTB. As such, the combination of these files operates to identify the location in the DTB audio file where each page begins and ends, and where each chapter begins and ends. After the administration portion of the DTB file is accessed, the method continues to step 206, where each page from the Daisy file is mapped into a new audio format. More particularly, the mapping process identifies the beginning and end of the audio file for each page in the DTB. Once these points are identified, the audio between the points is extracted and placed into a audio file format of the target media file type. The appropriate header or administration information is then attached to the new media file, e.g., information that identifies the new audio file as page X in chapter Y of book Z, for example. Once the audio file is generated and the mapping process has been completed for the page of the DTB, then the method continues to step 208, where the new file format is saved. The method continues through the identification and mapping process for each page in the DTB until all of the pages have been converted into the new audio file format. Once all of the files have been converted, the method is generally completed. The files may then be saved into a file structure for easy access and playback without having to search for the individual files that make up the various pages of the book in the new audio file format.

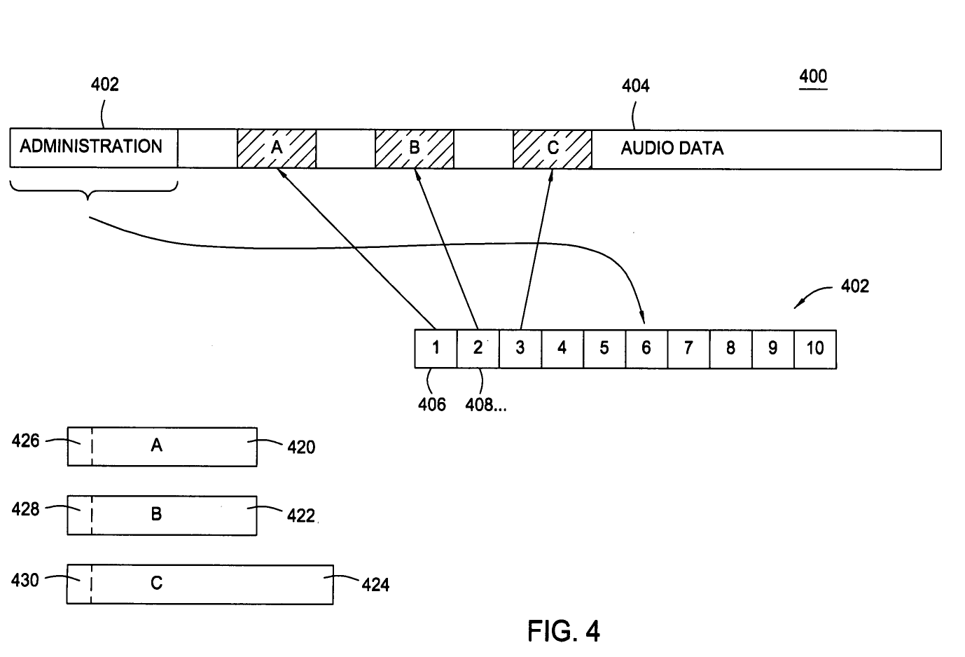

FIG. 3 illustrates a more detailed flowchart of an exemplary Daisy data file set conversion method of the invention. The applicants note that the Daisy data file set is intended to represent to package of information, which includes the NCX, SMIL, audio, etc. The method illustrated in FIG. 3 begins at step 302 and continues to step 304 where the administrative information of the Daisy file is accessed and parsed from the file. FIG. 4 illustrates an exemplary Daisy file structure 400. The exemplary Daisy file structure comprises a plurality of audio files (data portion 404) that are referenced by information within at least one SMIL file and controlled by information in at least one NCX file. Once the administrative information has been located, the method then continues to step 406, where the administration information from the data file set is processed so that the starting and ending points for each page in the DTB can be identified. The administrative information in portion 402 (e.g., SMIL and NCX files) generally indicates where each page and chapter of the DTB can be found in the audio data payload 404. As illustrated in FIG. 4, the portion 402 shows where the audio file, denoted as “A”, begins and ends for page 1. Similarly, the portion 402 shows where the audio file, denoted as “B”, begins and ends for page 2. Similarly, the portion 402 shows where the audio file, denoted as “C”, begins and ends for page 3. This type of mapping information and process, which is illustrated as step 305 in FIG. 3, may be used to identify lines, sentences, paragraphs, pages, chapters, etc. for audio information in a Daisy format DTB. The term identify, as used in the previous sentence, generally refers to determining the exact location of data/audio files in a Daisy file payload, wherein the audio files correspond to specific navigation points in the DTB, i.e., lines, sentences, paragraphs, pages, chapters, etc.

Once the audio files corresponding to the book pages, for example, have been identified, then the method continues to step 308, where audio files in the new streaming digital format are created. In FIG. 4, the new audio files are represented as 426 for page 1, 428 for page 2, and 430 for page 3. As illustrated, the audio payloads (A, B, and C) have been extracted from the Daisy file data payload 304 and has been parsed into separate audio files corresponding to the book pages (although the invention is not limited to any particular size or type of mapping—it may be pages, lines, chapters, etc.). Each of the new audio files may generally have its own administrative header-type information 426, 428, 430 that operates to identify the corresponding audio. Further, the header information in the new audio files may also indicate the next data file in the sequence (the next line, page, chapter, etc. in the book), if the user desires to play the files sequentially. Thus, the header may point to the starting point of the next audio file when the end of the current audio file is reached, so that the user gets a seamless audio playback that continues from page to page of the book without stopping, unless the user desires and/or selects to stop between each line, page, paragraph, etc. The process of linking all of the audio files together in this serial manner, for example, is shown at step 310 in FIG. 3, where the new audio files may be mapped. Thereafter, once the files are mapped, they may be stored in the new audio format for future playback on a player compatible with the new audio format, and the method ends at step 312.

The process of parsing the audio information for each line, page, paragraph, etc. may be conducted in a single extraction and mapping process, or alternatively, the extraction and mapping process may be done, for example, on a page by page basis. In this situation, the exemplary method illustrated in FIG. 3 may include a decision and loop-back step 314. For example, in the situation where the audio for each page is parsed individually, then the method will map and create the new audio file for each page individually—one at a time. When a current page, say page 1 for example, is completed, then the method may loop back to the beginning of the process and continue processing the Daisy audio file for page 2. This loop-back feature may be continued until each page in the DTB has been processed and converted into the new audio format.

Once the compilation of new audio files (426, 428, 430, etc.) has been created, the method of the invention may continue to index or map a collection of these files. For example, assuming that a book has 250 pages, then the method of the invention may collect the 250 new audio files and place them in a common memory location, such as a folder or directory. This will allow for a more efficient playback of the files, as the mapping will lead the new audio player to the same directory for each sequential file played.

In another embodiment of the invention, once the audio files representing the pages of the DTB have been created in the new audio format, the method of the invention may go further into the mapping process to achieve a finer granularity of the audio. For example, if the new audio files each contain a page of information, then the mapping method may further use either the old Daisy information or new mapping information associated with the audio file to further mark navigation points in the new audio files. If each audio file denotes a page, then the additional mapping function may be used to map or mark lines, sentences, paragraphs, etc.

In yet another embodiment of the invention, the Daisy header information may be passed into the header information for the new audio file. For example, if the new audio files are page sized and the Daisy DTB had navigation points corresponding to lines, paragraphs, and pages, then the navigation information for the lines and paragraphs may be mapped and passed to the new audio file header for use in navigating the new audio file representing the DTB.

While the foregoing is directed to embodiments of the present invention, other and further embodiments of the invention may be devised without departing from the basic scope thereof, and the scope thereof is determined by the claims that follow.

1. A method for converting a Daisy digital talking book data file set, comprising:
accessing administrative information in a Daisy file;
identifying a start and end point for a specific audio portion of the digital talking book;
parsing the specific audio portion from the Daisy file;
creating a new audio file using the parsed audio portion;
adding a header to the new audio file; and
saving the new audio file.

2. The method of claim 1, wherein the administrative information comprises a package file, a SMIL file, or an NCX file.

3. The method of claim 2, wherein identifying the start and end points comprises extracting navigation information from the SMIL file, wherein the navigation information comprises page start and stop locations in the Daisy file.

4. The method of claim 3, wherein parsing the information comprises:
identifying a starting point and an ending point for audio data representing a specific page from the digital talking book; and
copying the audio data from the Daisy file to a new audio file.

5. The method of claim 4, wherein adding the header comprises adding an administrative data portion to the new audio file, wherein the administrative data portion includes tags to specific navigation points in the new audio file.

6. The method of claim 5, wherein the steps of accessing, identifying, parsing, creating, adding, and saving are repeated until each page of the digital talking book is converted from the Daisy file format to a the new digital streaming media format.

7. The method of claim 6, wherein the new digital streaming media format comprises MPEG, MP3, WAV, WMA, WMV, MC, Windows Media, MC, or Advanced Streaming Format.

8. The method of claim 7, wherein the administrative data portion to the new audio file comprises information identifying a next data file in a sequence of data files the make up the digital talking book in the new audio format.

9. The method of claim 8, wherein the specific audio portion corresponds to a line, a paragraph, a page, or a chapter of a digital talking book.

10. A method for converting a Daisy format digital talking book file into a digital streaming media file, comprising:
accessing an admin portion of a Daisy file;
mapping specific portions of the Daisy audio file for the digital talking book from the admin portion of the Daisy file;
extracting individual audio files corresponding to specific portions of the digital talking book; and
saving the individual audio files in a digital streaming media format.

11. The method of claim 10, wherein admin portion of the Daisy file comprises a package file, a SMIL file, or an NCX file.

12. The method of claim 11, wherein mapping the specific portions comprises mapping lines, paragraphs, pages, or chapters of the digital talking book.

13. The method of claim 12, wherein the digital streaming media format comprises MPEG, MP3, WAV, WMA, WMV, Windows Media, MC, or Advanced Streaming Format.

14. Apparatus for converting a Daisy digital talking book file comprising:
a processor for accessing a Daisy digital talking book file and converting the Daisy file into a new audio file.

15. The apparatus of claim 14 wherein the processor further comprises:
means for accessing administrative information in a Daisy file;
means for identifying a start and end point for a specific audio portion of the digital talking book;
means for parsing the specific audio portion from the Daisy file;
means for creating a new audio file using the parsed audio portion;
means for adding a header to the new audio file; and
means for saving the new audio file.

16. The apparatus of claim 14, wherein the administrative information comprises a package file, a SMIL file, or an NCX file.
